(19) United States
(12) Patent Application Publication
(10) Pub. No.: US 2025/0039809 A1
(43) Pub. Date: Jan. 30, 2025

(54) SSB Indication Method and Device

(71) Applicant: VIVO MOBILE COMMUNICATION CO.,LTD., Dongguan (CN)

(72) Inventors: Lu Jiang, Dongguan (CN); Xiaohang Chen, Dongguan (CN)

(21) Appl. No.: 18/904,253

(22) Filed: Oct. 2, 2024

Related U.S. Application Data
(63) Continuation of application No. PCT/CN2023/086993, filed on Apr. 7, 2023.

(30) Foreign Application Priority Data
Apr. 7, 2022 (CN) 202210365347.0

(51) Int. Cl. H04W 56/00; H04W 48/08; H04W 74/00

(52) U.S. Cl. CPC H04W 56/001; H04W 48/08; H04W 74/006

(57) ABSTRACT

An SSB indication method includes UE receives first indication information sent by a network side device, where the first indication information is used to indicate related information of an SSB of the network side device. UE performs a target-related operation based on the first indication information, where the target-related operation is an operation related to a transmission state of the SSB. The related information of the SSB includes at least one of the following that the SSB is in a disabled state or an enabled state, a disabled time or an enabled time of the SSB, a disabled pattern or an enabled pattern of the SSB, validity of an RACH occasion corresponding to the SSB, or a state mask of the SSB on an RACH occasion corresponding to the SSB.

### CROSS-REFERENCE TO RELATED APPLICATIONS

This application is a Bypass Continuation application of International Patent Application No. PCT/CN2023/086993, filed Apr. 7, 2023, and claims priority to Chinese Patent Application No. 202210365347.0, filed Apr. 7, 2022, the disclosures of which are hereby incorporated by reference in their entireties.

### BACKGROUND OF THE INVENTION

### Field of the Invention

This application pertains to the field of communication technologies, and in particular, relates to an SSB indication method and a device.

### Description of Related Art

In a fifth generation (5G) system, a synchronization signal block (SSB) is used for cell search and mobility in an idle state, an inactive state, or a connected state. However, power consumption on a network side is relatively large, and power saving solutions on the network side become a focus in the communication field today. Currently, the network side may dynamically disable/enable a specific number of SSBs in spatial domain to achieve the purpose of power saving on the network side. When an SSB on the network side is changed dynamically, user equipment (UE) still performs measurement/monitoring/access based on an SSB pattern before the change, resulting in unnecessary resource waste.

### SUMMARY OF THE INVENTION

According to a first aspect, an SSB indication method is provided. The SSB indication method includes: UE receives first indication information sent by a network side device, where the first indication information is used to indicate related information of an SSB of the network side device. UE performs a target-related operation based on the first indication information, where the target-related operation is an operation related to a transmission state of the SSB. The related information of the SSB includes at least one of the following: that the SSB is in a disabled state or an enabled state, a disabled time or an enabled time of the SSB, a disabled pattern or an enabled pattern of the SSB, validity of a random access channel (RACH) occasion corresponding to the SSB, or a state mask of the SSB on an RACH occasion corresponding to the SSB.

According to a second aspect, an SSB indication apparatus is provided. The SSB indication apparatus includes a receiving module and an execution module. The receiving module is configured to receive first indication information sent by a network side device, where the first indication information is used to indicate related information of an SSB of the network side device. The execution module is configured to perform a target-related operation based on the first indication information received by the receiving module, where the target-related operation is an operation related to a transmission state of the SSB. The related information of the SSB includes at least one of the following: that the SSB is in a disabled state or an enabled state, a disabled time or an enabled time of the SSB, a disabled pattern or an enabled pattern of the SSB, validity of an RACH occasion corresponding to the SSB, or a state mask of the SSB on an RACH occasion corresponding to the SSB.

According to a third aspect, an SSB indication method is provided. The SSB indication method includes: A network side device sends first indication information to UE, where the first indication information is used to indicate related information of an SSB of the network side device. The first indication information is used by the UE to perform a target-related operation, where the target-related operation is an operation related to a transmission state of the SSB. The related information of the SSB includes at least one of the following: that the SSB is in a disabled state or an enabled state, a disabled time or an enabled time of the SSB, a disabled pattern or an enabled pattern of the SSB, validity of an RACH occasion corresponding to the SSB, or a state mask of the SSB on an RACH occasion corresponding to the SSB.

According to a fourth aspect, an SSB indication apparatus is provided. The SSB indication apparatus includes a sending module. The sending module is configured to send first indication information to UE, where the first indication information is used to indicate related information of an SSB of the network side device. The first indication information is used by the UE to perform a target-related operation, where the target-related operation is an operation related to a transmission state of the SSB. The related information of the SSB includes at least one of the following: that the SSB is in a disabled state or an enabled state, a disabled time or an enabled time of the SSB, a disabled pattern or an enabled pattern of the SSB, validity of an RACH occasion corresponding to the SSB, or a state mask of the SSB on an RACH occasion corresponding to the SSB.

According to a fifth aspect, UE is provided. The UE includes a processor and a memory, the memory stores a program or an instruction executable on the processor, and when the program or the instruction is executed by the processor, the steps of the method according to the first aspect are implemented.

According to a sixth aspect, UE is provided, including a processor and a communication interface. The communication interface is configured to receive first indication information sent by a network side device, where the first indication information is used to indicate related information of an SSB of the network side device. The processor is configured to perform a target-related operation based on the first indication information received by the receiving module, where the target-related operation is an operation related to a transmission state of the SSB. The related information of the SSB includes at least one of the following: that the SSB is in a disabled state or an enabled state, a disabled time or an enabled time of the SSB, a disabled pattern or an enabled pattern of the SSB, validity of an RACH occasion corresponding to the SSB, or a state mask of the SSB on an RACH occasion corresponding to the SSB.

According to a seventh aspect, a network side device is provided. The network side device includes a processor and a memory, the memory stores a program or an instruction executable on the processor, and when the program or the instruction is executed by the processor, the steps of the method according to the third aspect are implemented.

According to an eighth aspect, a network side device is provided, including a processor and a communication interface. The communication interface is configured to send first indication information to UE, where the first indication information is used to indicate related information of an SSB of the network side device. The first indication information is used by the UE to perform a target-related operation, where the target-related operation is an operation related to a transmission state of the SSB. The related information of the SSB includes at least one of the following: that the SSB is in a disabled state or an enabled state, a disabled time or an enabled time of the SSB, a disabled pattern or an enabled pattern of the SSB, validity of an RACH occasion corresponding to the SSB, or a state mask of the SSB on an RACH occasion corresponding to the SSB.

According to a ninth aspect, a communication system is provided, including UE and a network side device. The UE may be configured to perform the steps of the SSB indication method according to the first aspect, and the network side device may be configured to perform the steps of the SSB indication method according to the third aspect.

According to a tenth aspect, a non-transitory readable storage medium is provided. The non-transitory readable storage medium stores a program or an instruction, and when the program or the instruction is executed by a processor, the steps of the method according to the first aspect are implemented, or the steps of the method according to the third aspect are implemented.

According to an eleventh aspect, a chip is provided. The chip includes a processor and a communication interface. The communication interface is coupled to the processor, and the processor is configured to run a program or an instruction to implement the method according to the first aspect, or to implement the method according to the third aspect.

According to a twelfth aspect, a computer program/program product is provided. The computer program/program product is stored in a non-transitory storage medium, and the computer program/program product is executed by at least one processor to implement the steps of the SSB indication method according to the first aspect, or the steps of the SSB indication method according to the third aspect.

### BRIEF DESCRIPTION OF THE DRAWINGS

FIG. 1 is a schematic diagram of an architecture of a wireless communication system according to an embodiment of this application;

FIG. 2 is a first schematic diagram of an SSB indication method according to an embodiment of this application;

FIG. 3 is a first schematic diagram of a mapping relationship between an RACH resource and a PRU set according to an embodiment of this application;

FIG. 4 is a second schematic diagram of a mapping relationship between an RACH resource and a PRU set according to an embodiment of this application;

FIG. 5 is a first schematic diagram of a mapping relationship between an SSB and an RO according to an embodiment of this application;

FIG. 6 is a second schematic diagram of a mapping relationship between an SSB and an RO according to an embodiment of this application;

FIG. 7 is a third schematic diagram of a mapping relationship between an SSB and an RO according to an embodiment of this application;

FIG. 8 is a fourth schematic diagram of a mapping relationship between an SSB and an RO according to an embodiment of this application;

FIG. 9 is a second schematic diagram of an SSB indication method according to an embodiment of this application;

FIG. 10 is a fifth schematic diagram of a mapping relationship between an SSB and an RO according to an embodiment of this application;

FIG. 11 is a sixth schematic diagram of a mapping relationship between an SSB and an RO according to an embodiment of this application;

FIG. 12 is a first schematic diagram of a structure of an SSB indication apparatus according to an embodiment of this application;

FIG. 13 is a second schematic diagram of a structure of an SSB indication apparatus according to an embodiment of this application;

FIG. 14 is a schematic diagram of a hardware structure of a communication device according to an embodiment of this application;

FIG. 15 is a schematic diagram of a hardware structure of UE according to an embodiment of this application; and

FIG. 16 is a schematic structural diagram of hardware of a network side device according to an embodiment of this application.

### DESCRIPTION OF THE INVENTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing an order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in this specification and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. A new radio (NR) system is described in the following description for illustrative purposes, and the NR terminology is used in most of the following description, although these technologies can also be applied to applications other than the NR system application, such as the 6-th generation (6G) communication system.

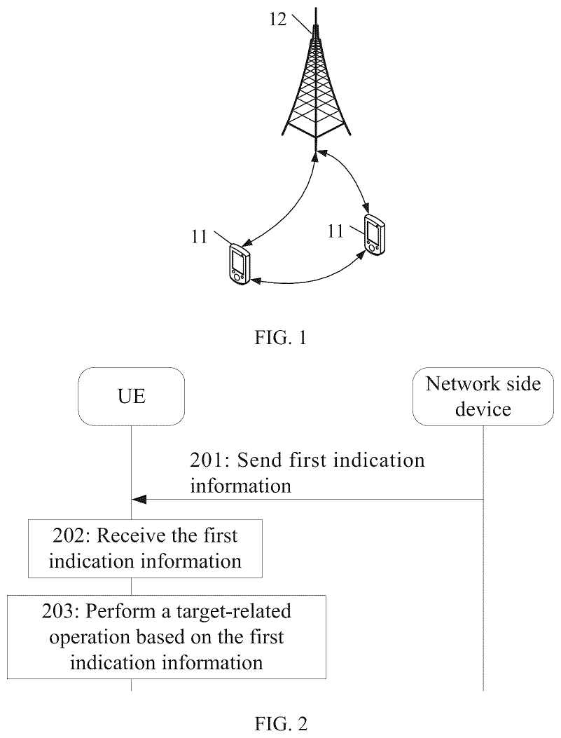

FIG. 1 is a block diagram of a wireless communication system to which the embodiments of this application may be applied. The wireless communication system includes UE 11 and a network side device 12. The UE 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), smart household (household devices with wireless communication functions, such as a refrigerator, a television, a washing machine, or furniture), a game console, a personal computer (PC), a teller machine, or a self-service machine, and the wearable device includes a smart watch, a smart band, smart earphones, smart glasses, smart jewelry (a smart bracelet, a smart hand chain, a smart ring, a smart necklace, a smart bangle, a smart anklet, or the like), a smart wristband, smart clothes, and the like. It should be noted that a type of the UE 11 is not limited in the embodiments of this application. The network side device 12 may include an access network device or a core network device. The access network device 12 may also be referred to as a radio access network device, a radio access network (RAN), a radio access network function, or a radio access network unit. The access network device 12 may include a base station, a WLAN access node, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another appropriate term in the art. As long as a same technical effect is achieved, the base station is not limited to a specified technical term. It should be noted that, in the embodiments of this application, only a base station in an NR system is used as an example, but a type of the base station is not limited.

The following describes some concepts and/or terms involved in an SSB indication method and apparatus, a device, a system, and a non-transitory storage medium provided in this embodiment of this application.

### Preamble

In LTE and NR, a random access process includes: A base station notifies UE of available random access preambles in advance by using system broadcast (for example, an initial access scenario) or a radio resource control (RRC) message. The UE selects one of the random access preambles as a temporary identifier of the UE, and sends a random access request to the base station.

A random access preamble is abbreviated as a preamble. A number of preambles and a number of physical random access channel (PRACH) occasions (per unit of time) actually determine a random access capacity of a cell. As resources (PRACH) used for random access increase, a capacity of random access increases, but correspondingly, resources used for uplink data decrease. Therefore, a resource configuration for random access needs to be considered with reference to a service model of the cell.

In one cell, each preamble is associated with one preamble index. If the UE receives a random access response and includes a preamble index corresponding to the preamble selected by the UE, the UE considers that the base station responds to its request.

In a protocol, PRACH resources or different preambles in different time domain or frequency domain are associated with SSB indices. In other words, the base station can in turn infer which SSB is the best downlink beam for a current terminal by using preamble indices detected in different time domain or frequency domain.

In CFRA, the UE and the base station do not need to send a message 3 (MSG3) and a message 4 (MSG4). If the UE receives an MSG2 (Random Access Response) that includes a preamble index corresponding to an MSG1 (Random Access Preamble), it is considered that the random access succeeds. In CFRA in an HO or SN addition scenario, a dedicated preamble corresponds to the UE, and in CFRA in an on-demand SI request scenario, a dedicated preamble corresponds to the SI.

Note: In the HO or SN addition scenario, even if the UE obtains the dedicated preamble, the UE does not necessarily perform random access in a CFRA manner. The reason is that a dedicated preamble allocated by the base station may be associated with an SSB beam (based on a previous measurement report of the UE). When the UE receives an RRC reconfiguration, if an SSB corresponding to the dedicated preamble does not meet a threshold (for example, reference signal receiving power (RSRP)) requirement, the UE may select another SSB and perform random access in a CBRA manner.

With reference to the accompanying drawings, an SSB indication method provided in the embodiments of this application is described in detail by using some embodiments and application scenarios thereof.

In a 5G system, a certain number of SSB beams can be dynamically disabled/enabled in spatial domain to achieve a purpose of network power saving. When an SSB beam on a network side is dynamically disabled, if the UE still performs measurement/monitoring/access based on an SSB pattern before the beams are disabled, unnecessary resource waste is caused. Therefore, the network side needs to notify the UE of a new SSB transmission state and a related RACH configuration, and indicates a new UE behavior.

This application provides a method of SSB muting on a network side for power saving, in which after entering a power saving mode, in a case that some SSBs are deactivated, association relationships between an SSB and an RO and between an SSB and a preamble need to be redefined.

Optionally, an embodiment of this application provides an SSB indication method. FIG. 2 shows a flowchart of an SSB indication according to an embodiment of this application. As shown in FIG. 2, the SSB indication method provided in this embodiment of this application may include the following step 201 to step 203.

Step 201: A network side device sends first indication information to UE.

Step 202: The UE receives the first indication information sent by the network side device.

In this embodiment of this application, the foregoing first indication information is used to indicate related information of an SSB of the network side device. The first indication information is used to instruct the UE to perform a target-related operation, where the target-related operation is an operation related to a transmission state of the SSB.

The related information of the SSB includes at least one of the following: that the SSB is in a disabled state or an enabled state, a disabled time or an enabled time of the SSB, a disabled pattern or an enabled pattern of the SSB, validity of an RACH occasion corresponding to the SSB, or a state mask of the SSB on an RACH occasion corresponding to the SSB.

In this embodiment of this application, when the SSB on the network side is dynamically changed, that is, the transmission state of the SSB is changed, the network side device may indicate the related information of the SSB to the UE, that is, indicate, to the UE, some related information of the SSB after the transmission state of the SSB is changed, so that the UE no longer performs measurement/monitoring/access based on an SSB pattern before the change. At this time, the UE can perform, based on the indicated related information of the SSB, the operation related to the transmission state of the SSB, to adapt to a current transmission state of the SSB, so that behavior of the UE is more accurate, and unnecessary resource waste is avoided.

Optionally, in this embodiment of this application, the foregoing first indication information is sent in a case that a working mode of the network side device is switched to a target mode. The foregoing first indication information is used to indicate that the transmission state of the SSB is changed; or the foregoing first indication information is used to instruct the UE to perform the operation related to the transmission state of the SSB.

It may be understood that the transmission state of the SSB is changed may correspond to a plurality of indication manners, for example, an indication is performed based on the working mode of the network side device, an indirect indication is performed based on validity of an RO (RACH occasion), or an indication is performed by using new signaling or other information.

It may be understood that, the network side device may send the first indication information to the UE in a case that a working mode of the network side device is switched to the target mode, to indicate that the transmission state of the SSB is changed, so that the UE performs the target-related operation, or directly instructs the UE to perform the operation related to the transmission state of the SSB. For example, after entering the power saving mode, the network side device disables some SSBs for power saving, and the network side device may send the first indication information to the UE.

Optionally, in this embodiment of this application, the foregoing target mode may be a first mode (for example, the power saving mode), a second mode (for example, a non-power saving mode), or another mode. That is, the network side device may be switched from the first mode to the second mode, from the second mode to the first mode, or the like.

For example, the foregoing target mode may be a power saving mode or a non-power saving mode, for example, the power saving mode may be a microsleep/light sleep/deep sleep mode, or a light sleep/medium sleep/deep sleep mode. That is, the network side device may notify the UE, by sending the first indication information to the UE, that the working mode of the network side device is changed (that is, the transmission state of the SSB is changed), so that the UE may perform, based on the changed working mode of the network side, a related operation corresponding to the working mode.

Optionally, in this embodiment of this application, the change of the transmission state of the SSB may further be indirectly indicated based on the validity of the RO (RACH occasion). When one SSB is mapped to one or more ROs, the network side device may directly indicate validity of an RO corresponding to the SSB by using an association relationship between the SSB and the RO, and indirectly indicate validity of the SSB by using the RO validity.

Optionally, in this embodiment of this application, the change of the transmission state of the SSB may further be indirectly indicated based on the validity of the RO. When a plurality of SSBs are associated with one RO, the network side device may indicate a transmission state of the SSBs associated with the RO by using an SSB state mask (for example, SSB per RO mask) in a unit of RO. Subsequently, only SSB-to-preamble mapping needs to be changed at the granularity of RO.

Optionally, in this embodiment of this application, the foregoing SSB includes any one of the following: an SSB actually transmitted by the network side device in the target mode, or all candidate SSBs of the network side device.

Optionally, in this embodiment of this application, in a case that the SSB includes the SSB actually transmitted by the network side device in the target mode, related information of an SSB before the network side device is switched to the target mode is indicated by the network side device by using an SSB location indication field, and related information of an SSB after the network side device is switched to the target mode is indicated by the network side device by using a target indication field.

Optionally, in this embodiment of this application, in a case that the SSB includes all candidate SSBs of the network side device, related information of an SSB before or after the network side device is switched to the target mode is indicated by the network side device by using an SSB location indication field.

It may be understood that, based on the SSB actually transmitted by the network side device in the target mode, the related information of the SSB may be indicated based on ssb-PositionsInBurst by using new signaling, that is, the indication is not indicated by using the SSB location indication field (ssb-PositionsInBurst). However, for all candidate SSBs of the network side device, the related information of the SSBs in the target mode is indicated by updating the SSB location indication field (ssb-PositionsInBurst).

Optionally, in this embodiment of this application, the foregoing step 201 may be implemented by the following step 201a, and the foregoing step 202 may be implemented by the following step 202a.

Step 201a: The network side device sends the first indication information to the UE by using any one of the following: RRC signaling, a system information block (SIB), downlink control information (DCI), or a medium access control-control element (MAC CE).

Optionally, in this embodiment of this application, the RRC signaling may be broadcast RRC signaling or dedicated RRC signaling. The foregoing SIB may be a SIB1. The foregoing DCI may be common DCI of a group of UE or UE-specific DCI.

Step 202a: The UE receives the first indication information sent by the network side device by using any one of the following: RRC signaling, a SIB, DCI, or an MAC CE.

Optionally, the SSB indication method provided in this embodiment of this application further includes the following step 301 and step 302.

Step 301: A network side device sends first configuration information to UE.

Step 302: The UE receives the first configuration information sent by the network side device.

In this embodiment of this application, the foregoing first configuration information is configuration information enabled by the network side device after the network side device enters a target mode.

The first configuration information includes at least one of the following: a specific RACH configuration in the target mode, indication information that there is a quasi-co-located (QCL) relationship between a disabled SSB and at least one SSB enabled in the target mode, a default reference SSB in the target mode, a specific SSB pattern in the target mode, a configuration of a specific SSB location indication field in the target mode, a specific preamble in the target mode (for example, a preamble generated by a specific root sequence), a physical uplink shared channel (PUSCH) resource of a target random access message in the target mode, an RSRP threshold in the target mode, or a target mapping relationship. The target mapping relationship is a mapping relationship from a combination of RACH occasions to a PUSCH resource unit (PRU) set, or a mapping relationship from a combination of preambles to a PRU set.

Optionally, in this embodiment of this application, the foregoing RACH configuration includes at least one of the following: a resource configuration of an RACH occasion, an RACH repetition number, a mapping relationship between an SSB and an RACH occasion, or a preamble related parameter reallocated by the network side device to the UE.

Optionally, in this embodiment of this application, the foregoing resource configuration of the RACH occasion is associated with the default reference SSB in the target mode.

Optionally, in this embodiment of this application, the foregoing resource configuration of the RACH occasion is associated with an SSB enabled in the target mode.

Optionally, in this embodiment of this application, the foregoing mapping relationship between the SSB and the RACH occasion may be indicated by ssb-perRACH-Occasion AndCB-PreamblesPerSSB, or may be indicated by ssb-perRACH-Occasion in BeamFailureRecoveryConfig.

Optionally, in this embodiment of this application, the foregoing preamble related parameter may include at least one of the following: a number of CB (contention based)/CF (contention free) preambles, an index of a CB/CF preamble, or a start index of a CB/CF preamble.

Optionally, in this embodiment of this application, the foregoing preamble related parameter may be a total number of random access preambles (totalNumberOfRA-Preambles), or a number of msgA CB preambles allocated to each SSB associated with each RO shared with a 4-step RACH in a 2-step RACH (msgA-CB-PreamblesPerSSB-PerSharedRO).

Optionally, in this embodiment of this application, the foregoing target random access message may be a message A (MsgA) in a 2-step random access process.

Optionally, in this embodiment of this application, when there is a QCL relationship between the disabled SSB and at least one SSB enabled in the target mode, before the network side device enters the power saving mode, there are eight SSBs. A bitmap of eight bits indicates an enabled/disabled state of the eight SSBs. The network side device indicates, by using first indication information ‘10111111’, a second SSB to be disabled. The first configuration information may be used to configure the second SSB to have a QCL relationship with a first SSB.

Optionally, in this embodiment of this application, the RSRP threshold in the target mode may be a message A RSRP threshold (MsgA-RSRP-Threshold) in a 2-step random access process. The UE may determine a random access type based on a network configuration parameter and the RSRP threshold. If the network configures access resources of both the 4-step and the 2-step, if the RSRP threshold is greater than msgA-RSRP-Threshold, the UE selects the 2-step for access. If the network configures only access resources of the 2-step, the UE selects a 2-step RACH for access. In other cases, the UE selects a 4-step RACH for access.

Optionally, in this embodiment of this application, the foregoing first configuration information includes the PUSCH resource of the target random access message. The PUSCH occasion resource of the foregoing target random access message has an association relationship with an RACH resource in a first mode (that is, an RACH resource associated with an updated SSB). Alternatively, the PUSCH occasion resource of the foregoing target random access message has an association relationship with an RACH resource in a second mode.

Optionally, in this embodiment of this application, the PUSCH resource of the target random access message in the target mode, the RSRP threshold and/or the target mapping relationship in the target mode are information configured for the 2-step RACH.

Optionally, in this embodiment of this application, the foregoing target mapping relationship may be a time offset of a location of the PRU set relative to an RACH slot.

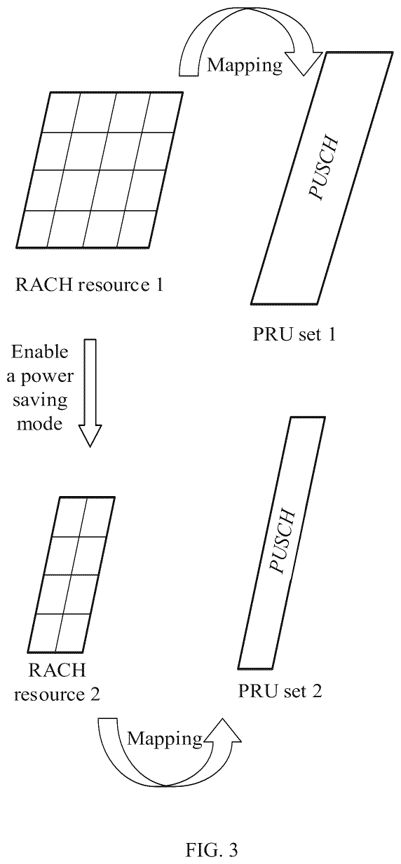

Example 1: As shown in FIG. 3, an SSB of the network side device that is in a non-power saving state is associated with an RACH resource 1, and a resource configuration of a PUSCH in a corresponding 2-step RACH is a PRU set 1. After the network side device enters a power saving state, the network side device sends the first configuration information to the UE, configures a new RACH resource 2 and a PRU set 2, and maps a combination of RACH occasions/preambles to a PRU in the PRU set 2.

In Example 1, different RACH resources are mapped to different PRU sets.

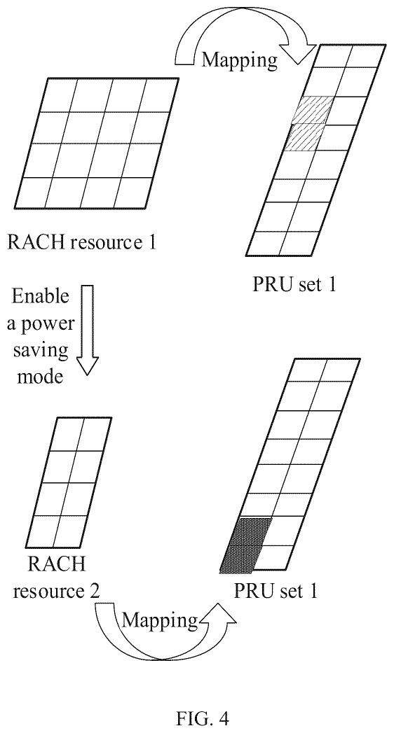

Example 2: As shown in FIG. 4, an SSB of the network side device that is in a non-power saving state is associated with an RACH resource 1, and a resource of a PUSCH in a corresponding 2-step RACH is a PRU set 1. After the network side device enters a power saving state, the network side device sends the first configuration information to the UE, configures a new RACH resource 2, and maps a combination of RACH occasions/preambles to a PRU in the PRU set 1.

In Example 2, different RACH resources are mapped to different PRUs of a same PRU set.

It should be noted that, in this embodiment of this application, the UE may first receive the first configuration information, and then receive the first indication information. Alternatively, the UE may first receive the first indication information, and then receive the first configuration information. Alternatively, the UE may simultaneously receive the first configuration information and the first indication information.

Step 203: The UE performs a target-related operation based on the first indication information.

Optionally, in this embodiment of this application, step 203 may be implemented by step 203a and step 203b.

Step 203a: The UE determines a target location based on the first indication information.

In this embodiment of this application, the foregoing target location is a location of an SSB that is actually transmitted by the network side device.

Step 203b: The UE performs the target-related operation based on the target location.

In this embodiment of this application, the foregoing target-related operation includes at least one of the following:
the UE stops sending a preamble on an RACH resource corresponding to an SSB disabled in a first mode;
the UE updates a mapping relationship between an SSB and an RACH occasion;
the UE cancels monitoring a target control resource set multiplexed with an SSB;
the UE determines validity of an RACH occasion;
the UE sends a specific preamble in the target mode;
the UE sends a preamble on a specific RACH occasion resource in the target mode;
the UE updates a mapping relationship between a PRACH and a PUSCH;
the UE determines validity of a PUSCH occasion;
the UE sends a PUSCH of a target random access message at a specific PUSCH occasion in the target mode; or
the UE does not send a PUSCH associated with an SSB disabled in a first mode (the PUSCH is associated with a PRACH corresponding to the disabled SSB).

Optionally, in this embodiment of this application, the foregoing target control resource set may be CORESET0, and the UE may cancel monitoring of CORESET0 multiplexed with the SSB.

Optionally, in this embodiment of this application, in a case that the foregoing target-related operation includes the UE determining the validity of the RACH occasion, the validity of the RACH occasion is determined by the UE on an SSB actually transmitted by the network side device in the target mode (that is, the validity of the RACH occasion is determined by the UE by using a target indication field after the network side device is switched to the target mode); or the validity of the RACH occasion is determined by the UE on all candidate SSBs of the network side device based on related information indicated by an SSB location indication field (that is, the validity of the RACH occasion is determined by the UE by using the SSB location indication field after the network side device is switched to the target mode).

It should be noted that, for the operations included in the foregoing target-related operation, the three operations that the UE stops sending the preamble on the RACH resource corresponding to the SSB disabled in the first mode, the UE cancels monitoring the target control resource set multiplexed with the SSB, and the UE does not send the PUSCH associated with the SSB disabled in the first mode are power saving related operations (that is, related operations in the first mode), while other operations may be power saving related operations, or may be non-power saving related operations (that is, related operations in the second mode).

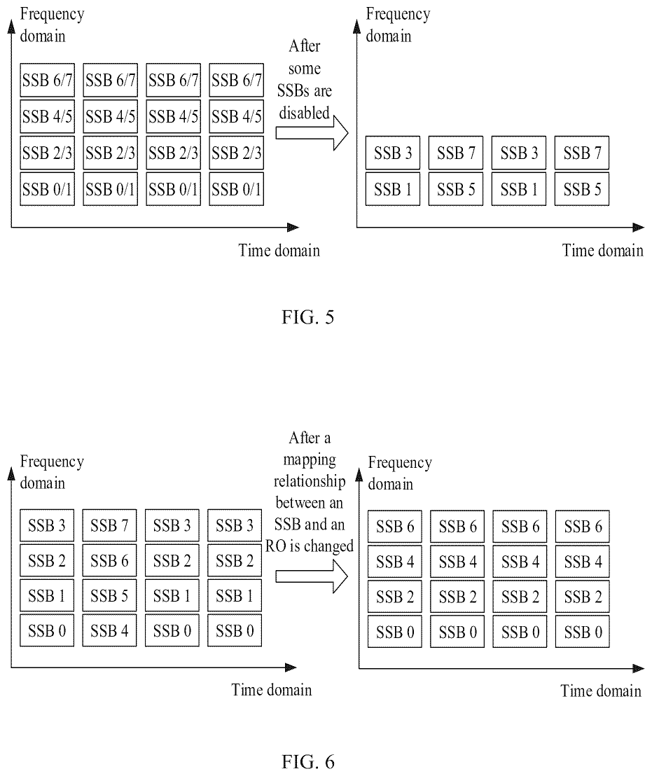

Example 3: There are eight SSBs (numbered in sequence from 0 to 7) on a network side, msg1−FDM=4 (denotes the number of frequency domain PRACH occasions), ssb-perRACH-Occasion=2, that is, each PRACH occasion (RO) is associated with two SSBs, totalNumberOfRA-Preambles=64, preamble indices corresponding to SSB 0 is 0 to 31, and preamble indices corresponding to SSB 1 is 32 to 64. A schematic diagram of a mapping relationship between the SSBs and the RO is shown in FIG. 5.

The UE and the network side device jointly maintain two sets of RACH configurations. It is specified that an RACH configuration 1 is used in a non-power saving network state. An RACH configuration 2 is used in a power saving network state. RACH resources in the RACH configuration 1 are shown in FIG. 5, and in this case, msg1−FDM=4. RACH resources in the RACH configuration 2 are shown in FIG. 5, and in this case, msg1−FDM=2.

It should be noted that the RACH configuration includes not only the RO resource configuration, but also the mapping from the SSBs to the RO, preamble allocation, and mapping from the RACH to the PUSCH in the 2-step RACH.

Step 1: The network is in a non-power saving state, and in the RACH configuration 1, eight SSBs are transmitted, where indexes of the eight SSBs are {0, 1, 2, 3, 4, 5, 6, 7}.

Step 2: The network side device sends the first configuration information, the network side device enters the power saving state, disables the SSBs 0\2\4\6, and the network side device sends the first indication information.

Step 3: The UE receives the first configuration information and the first indication information, and performs random access, PDCCH monitoring and measurement, rate matching, RO validation, and the like by using the RACH configuration 2 in the power saving mode.

Example 4: There are eight SSBs (numbered in sequence from 0 to 7) on a network side, msg1−FDM=4 (denotes a number of frequency domain PRACH occasions), ssb-perRACH-Occasion=1, that is, each PRACH occasion (RO) is associated with one SSB, and a schematic diagram of mapping between the SSB and the RO is shown in FIG. 6, that is, a mapping relationship between the SSB and the RO in the non-power saving mode.

Step 1: The network enters a power saving state, and the network side device disables SSB 1, SSB 3, SSB 5, and SSB 7.

Step 2: The network side device sends the first indication information to the UE to indicate that the network side device enters the power saving state.

Step 3: The UE receives the first indication information, and re-maps the SSB to the RACH occasion, as shown in FIG. 6, that is, a mapping relationship between the SSB and the RO in the power saving mode.

Step 4: The UE sends, based on the first indication information and the first configuration information, a preamble on an RO associated with an existing SSB.

In Example 4, the index of the SSB is not changed and an RO resource is not changed, but the network side and the UE side need to update the mapping relationship between the SSB and the RO.

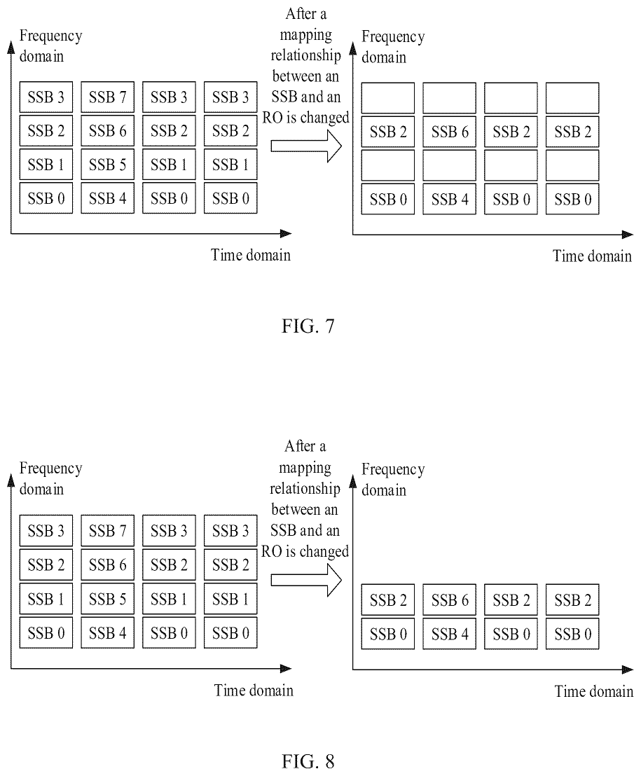

Example 5: There are eight SSBs (numbered in sequence from 0 to 7) on a network side, msg1−FDM=4 (denotes a number of frequency domain PRACH occasions), ssb-perRACH-Occasion=1, that is, each PRACH occasion (RO) is associated with one SSB, and a schematic diagram of mapping between the SSB and the RO is shown in FIG. 7, that is, a mapping relationship between the SSB and the RO in the non-power saving mode.

Step 1: The network enters a power saving state, and the network side device disables SSB 1, SSB 3, SSB 5, and SSB 7.

Step 2: The network side device sends the first indication information to the UE to indicate the disabled SSB beams.

Step 3: The UE receives the first indication information, and sends a preamble only on the ROs associated with the existing SSBs, as shown in FIG. 7, that is, a mapping relationship between the SSB and the RO after the SSB is disabled, and the remaining ROs are invalid.

In Example 5, the indexes of the SSB are not changed, RO resource is not changed, and the mapping relationship between the SSB and the RO does not need to be updated, but some ROs are invalid.

Example 6: There are eight SSBs (numbered in sequence from 0 to 7) on a network side, msg1−FDM=4 (denotes a number of frequency domain PRACH occasions), ssb-perRACH-Occasion=1, that is, each PRACH occasion (RO) is associated with one SSB, and a schematic diagram of mapping between the SSB and the RO is shown in FIG. 8, that is, a mapping relationship between the SSB and the RO in the non-power saving mode.

Step 1: The network enters a power saving state, and the network side device disables SSB 1, SSB 3, SSB 5, and SSB 7.

Step 2: The network side device sends the first indication information to the UE to indicate the disabled SSB beams.

Step 3: The network side device sends the first configuration information to the UE, and update an RO resource configuration, that is, msg1−FDM=2.

Step 4: The UE receives the first indication information and the first configuration information, and the remaining SSBs are re-mapped to a new RO resource.

Step 5: The UE sends a preamble on an RO associated with an existing SSB, as shown in FIG. 8, that is, a mapping relationship between the SSB and the RO after the SSB is disabled.

In Example 6, the indexes of the SSB are not changed, an RO resource is changed, and the mapping relationship between the SSB and the RO needs to be updated.

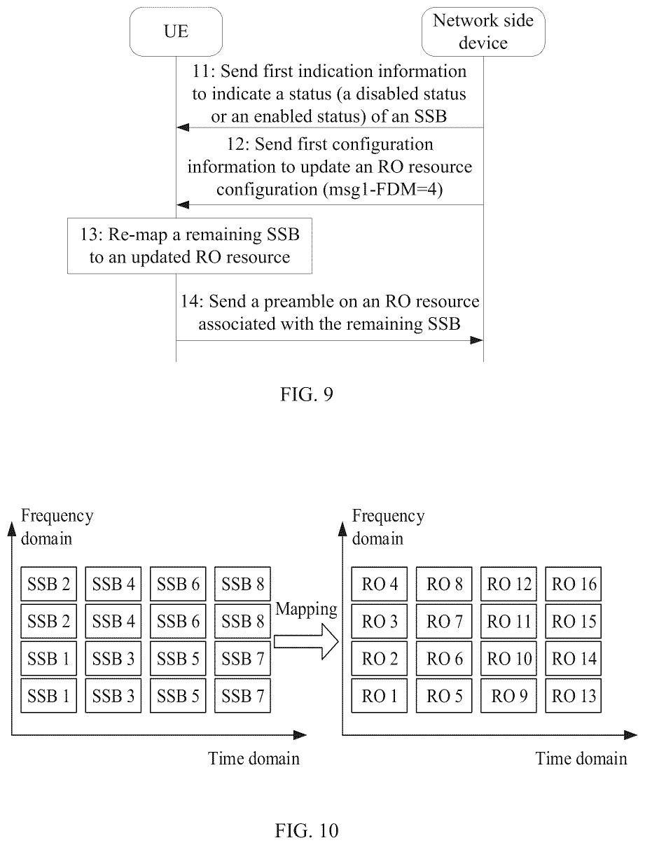

Optionally, in this embodiment of this application, as shown in FIG. 9, a signaling interaction process between the network side and the UE side may include the following step 11 to step 14.

Step 11: The network side device sends first indication information to the UE to indicate a state (a disabled state or an enabled state) of an SSB.

Step 12: The network side device sends first configuration information to the UE to update an RO resource configuration (msg1−FDM=4).

Step 13: The UE re-maps the remaining SSBs to the updated RO resource.

Step 14: The UE sends a preamble on the RO resource associated with the remaining SSB.

Example 7: Before the power saving mode, each SSB is mapped to two ROs. As shown in FIG. 10, SSB 1 is mapped to RO 1 and RO 2, and SSB 2 is mapped to RO 3 and RO 4, and so on.

After entering the power saving mode, the network side device disables the SSB 2 for power saving. The UE receives first indication information, where the indication information indicates that the RO 3 and the RO 4 corresponding to the SSB 2 are invalid, and the UE cannot subsequently send a preamble on each of the RO 3 and the RO 4.

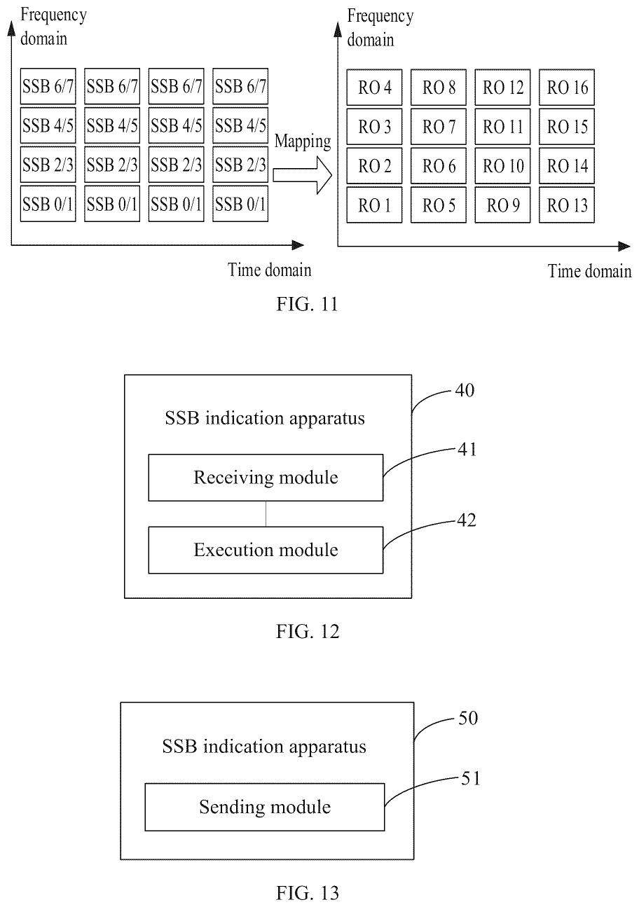

Example 8: Before the power saving mode, every two SSBs are mapped to one RO. As shown in FIG. 11, SSB 0 and SSB 1 are mapped to RO 1, and SSB 2 and SSB 3 are mapped to RO 2, and so on.

After entering the power saving mode, the network side device disables some SSBs for power saving. The UE receives first indication information, where the indication information indicates a state of the SSBs in each RO by using two bits, that is, SSB per RO mask, and one low-order bit indicates a state of a lower SSB index, and one high-order bit indicates a state of a higher SSB index. For example, if SSB per RO={0,1}, then an SSB with a smaller SSB number in each RO is disabled.

Subsequent possible behaviors of the UE include: (1) The network side device sends first configuration information to allocate a new preamble mapping relationship, and the UE may send a preamble on the corresponding RO; or (2) A preamble allocation relationship remains unchanged, but the UE cannot subsequently send, on a corresponding RO, a preamble corresponding to the disabled SSB.

Example 9: The network side device has eight candidate SSBs. The network side device and the UE jointly maintain configurations of two sets of SSB patterns. In the non-power saving state, a configuration of ssb-PositionsInBurst is {11110000}, that is, transmitted SSB indices are {0, 1, 2, 3}, and this configuration is configuration 1. In the power saving state, a dedicated configuration of ssb-PositionsInBurst is {10100000}, that is, transmitted SSB indices are {0,2}, and this configuration is configuration 2.

Step 1: The network side device is in the non-power saving state, and a configuration of ssb-PositionsInBurst is configuration 1.

Step 2: The network side device enters the power saving state, and indicates to the UE by using RRC/DCI that the configuration of ssb-PositionsInBurst is updated to configuration 2.

Step 3: Based on new ssb-PositionsInBurst, the UE performs rate matching on PDSCH data, determines validity of an RO, determines validity of PDCCH monitoring, and the like.

In this embodiment of this application, the effects of SSB muting on random access of the UE is considered, and a solution for indicating whether the SSB is sent or not is provided. For a solution in the power saving mode (less SSBs are sent), a new behavior of the UE is given, including performing rate matching on PDSCH data, determining validity of an RO, determining validity of PDCCH monitoring, performing re-mapping from SSB to RO, and the like.

This embodiment of this application provides an SSB indication method, in which UE may perform a target-related operation (that is, an operation related to a transmission state of the SSB) based on first indication information (used to indicate related information of an SSB) sent by a network side device. In this solution, when the SSB on the network side is dynamically changed, that is, the transmission state of the SSB is changed, the network side device may indicate the related information of the SSB to the UE, that is, indicate, to the UE, some related information of the SSB after the transmission state of the SSB is changed. This allows the UE to perform, based on the indicated related information of the SSB, an operation related to the transmission state of the SSB, to adapt to a current transmission state of the SSB, instead of still performing measurement/monitoring/access based on an SSB pattern before the change, so that a behavior of the UE is more accurate, and unnecessary resource waste is avoided.

It should be noted that the SSB indication method provided in the embodiments of this application may be further performed by an SSB indication apparatus, or a control module that is included in an SSB indication apparatus and that is configured to perform the SSB indication method.

FIG. 12 shows a possible schematic diagram of a structure of an SSB indication apparatus according to an embodiment of this application, and the SSB indication apparatus is applied to UE. As shown in FIG. 12, an SSB indication apparatus 40 may include a receiving module 41 and an execution module 42.

The receiving module 41 is configured to receive first indication information sent by a network side device, where the first indication information is used to indicate related information of an SSB of the network side device. The execution module 42 is configured to perform a target-related operation based on the first indication information received by the receiving module 41, where the target-related operation is an operation related to a transmission state of the SSB. The related information of the SSB includes at least one of the following: that the SSB is in a disabled state or an enabled state, a disabled time or an enabled time of the SSB, a disabled pattern or an enabled pattern of the SSB, validity of an RACH occasion corresponding to the SSB, or a state mask of the SSB on an RACH occasion corresponding to the SSB.

This embodiment of this application provides an SSB indication apparatus. When the SSB on the network side is dynamically changed, that is, the transmission state of the SSB is changed, the network side device may indicate the related information of the SSB to the UE, that is, indicate, to the UE, some related information of the SSB after the transmission state of the SSB is changed. This allows the UE to perform, based on the indicated related information of the SSB, an operation related to the transmission state of the SSB, to adapt to a current transmission state of the SSB, instead of still performing measurement/monitoring/access based on an SSB pattern before the change, so that a behavior of the UE is more accurate, and unnecessary resource waste is avoided.

In a possible implementation, the foregoing first indication information is sent in a case that a working mode of the network side device is switched to a target mode. The first indication information is used to indicate that the transmission state of the SSB is changed; or the first indication information is used to instruct the UE to perform the operation related to the transmission state of the SSB.

In a possible implementation, the foregoing SSB includes any one of the following: an SSB actually transmitted by the network side device in the target mode, or all candidate SSBs of the network side device.

In a possible implementation, in a case that the SSB includes the SSB actually transmitted by the network side device in the target mode, related information of an SSB before the network side device is switched to the target mode is indicated by the network side device by using an SSB location indication field, and related information of an SSB after the network side device is switched to the target mode is indicated by the network side device by using a target indication field. In a case that the SSB includes all candidate SSBs of the network side device, related information of an SSB before or after the network side device is switched to the target mode is indicated by the network side device by using an SSB location indication field.

In a possible implementation, the foregoing receiving module 41 is configured to receive the first indication information sent by the network side device by using any one of the following: RRC signaling, a SIB, DCI, or an MAC CE.

In a possible implementation, the receiving module 41 is further configured to receive first configuration information sent by the network side device, where the first configuration information is configuration information enabled by the network side device after the network side device enters the target mode. The first configuration information includes at least one of the following: a specific RACH configuration in the target mode, indication information that there is a QCL relationship between a disabled SSB and at least one SSB enabled in the target mode, a default reference SSB in the target mode, a specific SSB pattern in the target mode, a configuration of a specific SSB location indication field in the target mode, a specific preamble in the target mode, a PUSCH resource of a target random access message in the target mode, an RSRP threshold in the target mode, or a target mapping relationship; and the target mapping relationship is a mapping relationship from a combination of RACH occasions to a PRU set, or a mapping relationship from a combination of preambles to a PRU set.

In a possible implementation, the foregoing RACH configuration includes at least one of the following: a resource configuration of an RACH occasion, an RACH repetition number, a mapping relationship between an SSB and an RACH occasion, or a preamble related parameter reallocated by the network side device to the UE.

In a possible implementation, the foregoing resource configuration of the RACH occasion is associated with the default reference SSB in the target mode. Alternatively, the foregoing resource configuration of the RACH occasion is associated with an SSB enabled in the target mode.

In a possible implementation, the foregoing first configuration information includes the PUSCH resource of the target random access message. The PUSCH occasion resource of the target random access message has an association relationship with an RACH resource in a first mode. Alternatively, the PUSCH occasion resource of the target random access message has an association relationship with an RACH resource in a second mode.

In a possible implementation, the execution module 42 is configured to: determine a target location based on the first indication information, where the target location is a location of an SSB actually transmitted by the network side device; and perform the target-related operation based on the target location, where the target-related operation includes at least one of the following:
the UE stops sending a preamble on an RACH resource corresponding to an SSB disabled in a first mode;
the UE updates a mapping relationship between an SSB and an RACH occasion;
the UE cancels monitoring a target control resource set multiplexed with an SSB;
the UE determines validity of an RACH occasion;
the UE sends a specific preamble in the target mode;
the UE sends a preamble on a specific RACH occasion resource in the target mode;
the UE updates a mapping relationship between a PRACH and a PUSCH;
the UE determines validity of a PUSCH occasion;
the UE sends a PUSCH of a target random access message at a specific PUSCH occasion in the target mode; or
the UE does not send a PUSCH associated with an SSB disabled in a first mode.

The SSB indication apparatus in this embodiment of this application may be UE, such as UE with an operating system, or may be a component in the UE, such as an integrated circuit or a chip. The UE may be a terminal, or another device other than the terminal. For example, the UE may include but is not limited to the foregoing listed types of the UE 11 The another device may be a server, a network attached storage (NAS), or the like. This is not limited in the embodiments of this application.

The SSB indication apparatus provided in this embodiment of this application can implement the processes implemented by the UE in the foregoing method embodiments, and achieve a same technical effect. To avoid repetition, details are not described herein again.

FIG. 13 shows a possible schematic diagram of another structure of an SSB indication apparatus according to an embodiment of this application, and the SSB indication apparatus is applied to a network side device. As shown in FIG. 13, an SSB indication apparatus 50 may include a sending module 51.

The sending module 51 is configured to send first indication information to UE, where the first indication information is used to indicate related information of an SSB of the network side device. The first indication information is used by the UE to perform a target-related operation, where the target-related operation is an operation related to a transmission state of the SSB. The related information of the SSB includes at least one of the following: that the SSB is in a disabled state or an enabled state, a disabled time or an enabled time of the SSB, a disabled pattern or an enabled pattern of the SSB, validity of an RACH occasion corresponding to the SSB, or a state mask of the SSB on an RACH occasion corresponding to the SSB.

This embodiment of this application provides an SSB indication apparatus. When the SSB on the network side is dynamically changed, that is, the transmission state of the SSB is changed, the network side device may indicate the related information of the SSB to the UE, that is, indicate, to the UE, some related information of the SSB after the transmission state of the SSB is changed. This allows the UE to perform, based on the indicated related information of the SSB, an operation related to the transmission state of the SSB, to adapt to a current transmission state of the SSB, instead of still performing measurement/monitoring/access based on an SSB pattern before the change, so that a behavior of the UE is more accurate, and unnecessary resource waste is avoided.

In a possible implementation, the sending module 51 is configured to send the first indication information to the UE in a case that a working mode of the network side device is switched to a target mode. The first indication information is used to indicate that the transmission state of the SSB is changed; or the first indication information is used to instruct the UE to perform the operation related to the transmission state of the SSB.

In a possible implementation, the foregoing sending module 51 is configured to send the first indication information to the UE by using any one of the following: RRC signaling, a SIB, DCI, or an MAC CE.

In a possible implementation, the sending module 51 is further configured to send first configuration information to the UE, where the first configuration information is configuration information enabled by the network side device after the network side device enters the target mode. The first configuration information includes at least one of the following: a specific RACH configuration in the target mode, indication information that there is a QCL relationship between a disabled SSB and at least one SSB enabled in the target mode, a default reference SSB in the target mode, a specific SSB pattern in the target mode, a configuration of a specific SSB location indication field in the target mode, a specific preamble in the target mode, a PUSCH resource of a target random access message in the target mode, an RSRP threshold in the target mode, or a target mapping relationship; and the target mapping relationship is a mapping relationship from a combination of RACH occasions to a PRU set, or a mapping relationship from a combination of preambles to a PRU set.

The SSB indication apparatus provided in this embodiment of this application can implement the processes implemented by the network side device in the foregoing method embodiments, and achieve a same technical effect. To avoid repetition, details are not described herein again.

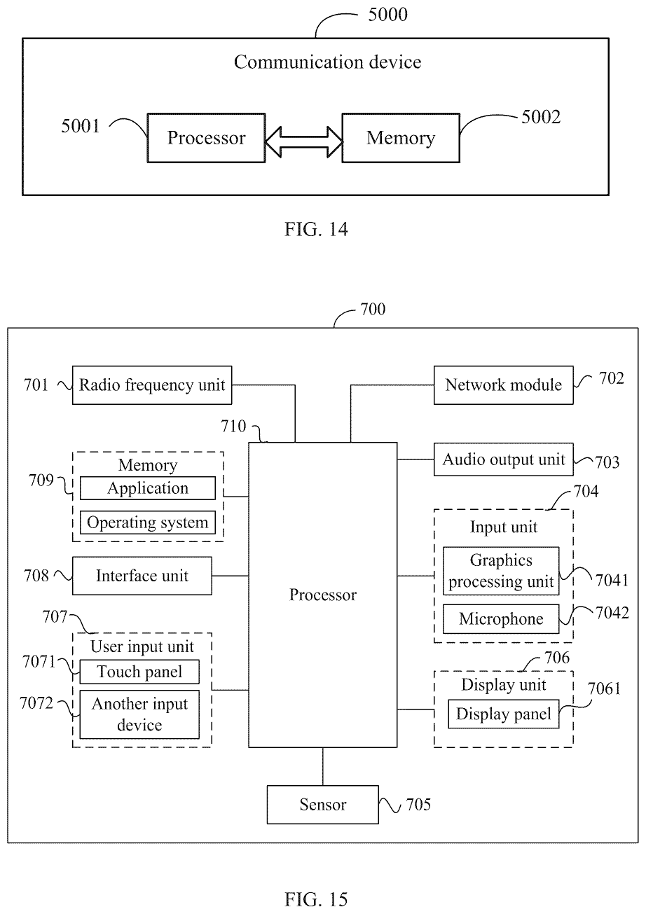

Optionally, as shown in FIG. 14, an embodiment of this application further provides a communication device 5000, including a processor 5001 and a memory 5002. The memory 5002 stores a program or an instruction executable on the processor 5001. For example, when the communication device 5000 is UE, when the program or the instruction is executed by the processor 5001, steps of the foregoing method embodiments on the UE side are implemented, and a same technical effect can be achieved. When the communication device 5000 is a network side device, when the program or the instruction is executed by the processor 5001, steps of the foregoing method embodiments of the network side device are implemented, and a same technical effect can be achieved. To avoid repetition, details are not described herein again.

An embodiment of this application further provides UE, including a processor and a communication interface. The communication interface is configured to receive first indication information sent by a network side device, where the first indication information is used to indicate related information of an SSB of the network side device. The processor is configured to perform a target-related operation based on the first indication information received by the receiving module, where the target-related operation is an operation related to a transmission state of the SSB. The related information of the SSB includes at least one of the following: that the SSB is in a disabled state or an enabled state, a disabled time or an enabled time of the SSB, a disabled pattern or an enabled pattern of the SSB, validity of an RACH occasion corresponding to the SSB, or a state mask of the SSB on an RACH occasion corresponding to the SSB. The UE embodiment corresponds to the foregoing method embodiments on the UE side, the implementation processes and implementations of the foregoing method embodiments can be applied to the UE embodiment, and a same technical effect can be achieved. FIG. 15 is a schematic diagram of a hardware structure of UE for implementing the embodiments of this application.

UE 700 includes but is not limited to at least a part of components such as a radio frequency unit 701, a network module 702, an audio output unit 703, an input unit 704, a sensor 705, a display unit 706, a user input unit 707, an interface unit 708, a memory 709, and a processor 710.

It may be understood by a person skilled in the art that the UE 700 may further include a power supply (such as a battery) that supplies power to each component. The power supply may be logically connected to the processor 710 by using a power management system, to implement functions such as charging, discharging, and power consumption management by using the power management system. The UE structure shown in FIG. 15 constitutes no limitation on the UE, and the UE may include more or fewer components than those shown in the figure, or combine some components, or have different component arrangements. Details are not described herein.

It should be understood that in this embodiment of this application, the input unit 704 may include a graphics processing unit (GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, the radio frequency unit 701 receives downlink data from a network side device and then sends the downlink data to the processor 710 for processing; and the radio frequency unit 701 may send uplink data to the network side device. Usually, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 709 in this embodiment of this application includes but is not limited to these memories and any memory of another proper type.

The processor 710 may include one or more processing units. Optionally, an application processor and a modem processor may be integrated into the processor 710. The application processor mainly processes an operating system, a user interface, an application, and the like. The modem processor mainly processes a wireless communication signal, for example, a baseband processor. It may be understood that, alternatively, the modem processor may not be integrated into the processor 710.

The radio frequency unit 701 is configured to receive first indication information sent by a network side device, where the first indication information is used to indicate related information of an SSB of the network side device.

The processor 710 is configured to perform a target-related operation based on the first indication information received by the receiving module, where the target-related operation is an operation related to a transmission state of the SSB. The related information of the SSB includes at least one of the following: that the SSB is in a disabled state or an enabled state, a disabled time or an enabled time of the SSB, a disabled pattern or an enabled pattern of the SSB, validity of an RACH occasion corresponding to the SSB, or a state mask of the SSB on an RACH occasion corresponding to the SSB.

This embodiment of this application provides UE. When the SSB on the network side is dynamically changed, that is, the transmission state of the SSB is changed, the network side device may indicate the related information of the SSB to the UE, that is, indicate, to the UE, some related information of the SSB after the transmission state of the SSB is changed. This allows the UE to perform, based on the indicated related information of the SSB, an operation related to the transmission state of the SSB, to adapt to a current transmission state of the SSB, instead of still performing measurement/monitoring/access based on an SSB pattern before the change, so that a behavior of the UE is more accurate, and unnecessary resource waste is avoided.

The UE provided in this embodiment of this application can implement the processes implemented by the UE in the foregoing method embodiments, and achieve a same technical effect. To avoid repetition, details are not described herein again.

An embodiment of this application further provides a network side device, including a processor and a communication interface. The communication interface is configured to send first indication information to UE, where the first indication information is used to indicate related information of an SSB of the network side device. The first indication information is used by the UE to perform a target-related operation, where the target-related operation is an operation related to a transmission state of the SSB. The related information of the SSB includes at least one of the following: that the SSB is in a disabled state or an enabled state, a disabled time or an enabled time of the SSB, a disabled pattern or an enabled pattern of the SSB, validity of an RACH occasion corresponding to the SSB, or a state mask of the SSB on an RACH occasion corresponding to the SSB. The network side device embodiment corresponds to the foregoing method embodiments on the network side device side. The implementation processes and implementations of the foregoing method embodiment may be applicable to the network side device embodiment, and a same technical effect can be achieved.

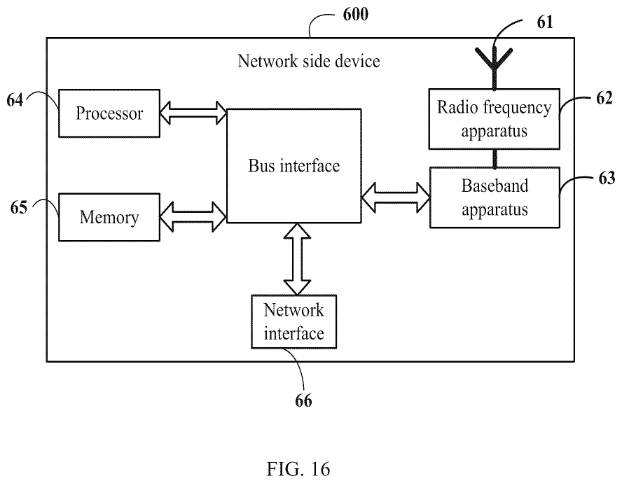

Optionally, an embodiment of this application further provides a network side device. As shown in FIG. 16, the network side device 600 includes an antenna 61, a radio frequency apparatus 62, a baseband apparatus 63, a processor 64, and a memory 65. The antenna 61 is connected to the radio frequency apparatus 62. In an uplink direction, the radio frequency apparatus 62 receives information by using the antenna 61, and sends the received information to the baseband apparatus 63 for processing. In a downlink direction, the baseband apparatus 63 processes information that needs to be sent, and sends processed information to the radio frequency apparatus 62. The radio frequency apparatus 62 processes the received information, and sends processed information by using the antenna 61.

In the foregoing embodiment, the method performed by the network side device may be implemented in a baseband apparatus 63. The baseband apparatus 63 includes a baseband processor.

The radio frequency apparatus 62 is configured to send first indication information to UE, where the first indication information is used to indicate related information of an SSB of the network side device. The first indication information is used by the UE to perform a target-related operation, where the target-related operation is an operation related to a transmission state of the SSB. The related information of the SSB includes at least one of the following: that the SSB is in a disabled state or an enabled state, a disabled time or an enabled time of the SSB, a disabled pattern or an enabled pattern of the SSB, validity of an RACH occasion corresponding to the SSB, or a state mask of the SSB on an RACH occasion corresponding to the SSB.

This embodiment of this application provides a network side device. When the SSB on the network side is dynamically changed, that is, the transmission state of the SSB is changed, the network side device may indicate the related information of the SSB to the UE, that is, indicate, to the UE, some related information of the SSB after the transmission state of the SSB is changed. This allows the UE to perform, based on the indicated related information of the SSB, an operation related to the transmission state of the SSB, to adapt to a current transmission state of the SSB, instead of still performing measurement/monitoring/access based on an SSB pattern before the change, so that a behavior of the UE is more accurate, and unnecessary resource waste is avoided.

The network side device provided in this embodiment of this application can implement the processes implemented by the network side device in the foregoing method embodiments, and achieve a same technical effect. To avoid repetition, details are not described herein again.

For example, the baseband apparatus 63 may include at least one baseband board. A plurality of chips are disposed on the baseband board. As shown in FIG. 16, one chip is, for example, a baseband processor, and is connected to the memory 65 by using a bus interface, to invoke a program in the memory 65 to perform the operations of the network device shown in the foregoing method embodiment.

The network side device may further include a network interface 66, and the interface is, for example, a common public radio interface (CPRI).

Optionally, the network side device 600 in this embodiment of this application further includes an instruction or a program stored in the memory 65 and executable on the processor 64. The processor 64 invokes the instruction or the program in the memory 65 to perform the method performed by the modules shown in FIG. 13, and a same technical effect is achieved. To avoid repetition, details are not described herein again.

An embodiment of this application further provides a non-transitory readable storage medium. The non-transitory readable storage medium stores a program or an instruction. When the program or the instruction is executed by a processor, the processes of the foregoing method embodiment are implemented, and same technical effect can be achieved. To avoid repetition, details are not described herein again.

The processor is a processor in the communication device in the foregoing embodiment. The non-transitory readable storage medium includes a non-transitory computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing method embodiment, and same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a non-transitory storage medium, and the computer program/program product is executed by at least one processor to implement the processes of the foregoing method embodiment, and a same technical effect can be achieved. To avoid repetition, details are not described herein again.

An embodiment of this application further provides a communication system, including UE and a network side device. The UE may be configured to perform the steps of the foregoing SSB indication method, and the network side device may be configured to perform the steps of the foregoing SSB indication method.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A synchronization signal block (SSB) indication method, wherein the method comprises:
receiving, by user equipment (UE), first indication information sent by a network side device, wherein the first indication information is used to indicate related information of an SSB of the network side device; and
performing, by the UE, a target-related operation based on the first indication information, wherein the target-related operation is an operation related to a transmission state of the SSB, wherein
the related information of the SSB comprises at least one of the following: that the SSB is in a disabled state or an enabled state, a disabled time or an enabled time of the SSB, a disabled pattern or an enabled pattern of the SSB, validity of a random access channel (RACH) occasion corresponding to the SSB, or a state mask of the SSB on the RACH occasion corresponding to the SSB.

2. The method according to claim 1, wherein the first indication information is sent in a case that a working mode of the network side device is switched to a target mode; and
the first indication information is used to indicate that the transmission state of the SSB is changed; or
the first indication information is used to instruct the UE to perform operations related to the transmission state of the SSB.

3. The method according to claim 2, wherein the SSB comprises any one of the following: an SSB actually transmitted by the network side device in the target mode, or all candidate SSBs of the network side device.

4. The method according to claim 3, wherein in a case that the SSB comprises the SSB actually transmitted by the network side device in the target mode, related information of an SSB before the network side device is switched to the target mode is indicated by the network side device by using an SSB location indication field, and related information of an SSB after the network side device is switched to the target mode is indicated by the network side device by using a target indication field; or
in a case that the SSB comprises all candidate SSBs of the network side device, related information of an SSB before or after the network side device is switched to the target mode is indicated by the network side device by using an SSB location indication field.

5. The method according to claim 1, wherein the receiving, by UE, first indication information sent by a network side device comprises:
receiving, by the UE, the first indication information sent by the network side device by using any one of the following: radio resource control (RRC) signaling, a system information block (SIB), downlink control information (DCI), or a medium access control-control element (MAC CE).

6. The method according to claim 1, wherein the method further comprises:
receiving, by the UE, first configuration information sent by the network side device, wherein the first configuration information is configuration information enabled by the network side device after the network side device enters a target mode, wherein
the first configuration information comprises at least one of the following: a specific RACH configuration in the target mode, indication information that there is a quasi-co-located (QCL) relationship between a disabled SSB and at least one SSB enabled in the target mode, a default reference SSB in the target mode, a specific SSB pattern in the target mode, a configuration of a specific SSB location indication field in the target mode, a specific preamble in the target mode, a physical uplink shared channel (PUSCH) resource of a target random access message in the target mode, a reference signal receiving power (RSRP) threshold in the target mode, or a target mapping relationship; and
the target mapping relationship is a mapping relationship from a combination of RACH occasions to a PUSCH resource unit (PRU) set, or a mapping relationship from a combination of preambles to a PRU set.

7. The method according to claim 6, wherein the RACH configuration comprises at least one of the following: a resource configuration of an RACH occasion, an RACH repetition number, a mapping relationship between an SSB and an RACH occasion, or a preamble related parameter reallocated by the network side device to the UE.

8. The method according to claim 7, wherein the resource configuration of the RACH occasion is associated with the default reference SSB in the target mode; or
the resource configuration of the RACH occasion is associated with an SSB enabled in the target mode.

9. The method according to claim 6, wherein the first configuration information comprises the PUSCH resource of the target random access message; and
a PUSCH occasion resource of the target random access message is associated with an RACH resource in a first mode; or
a PUSCH occasion resource of the target random access message is associated with an RACH resource in a second mode.

10. The method according to claim 1, wherein the performing, by the UE, a target-related operation based on the first indication information comprises:
determining, by the UE, a target location based on the first indication information, wherein the target location is a location of an SSB actually transmitted by the network side device; and
performing, by the UE, the target-related operation based on the target location, wherein the target-related operation comprises at least one of the following:
stopping, by the UE, sending a preamble on an RACH resource corresponding to an SSB disabled in a first mode;
updating, by the UE, a mapping relationship between an SSB and an RACH occasion;
canceling, by the UE, monitoring a target control resource set multiplexed with an SSB;
determining, by the UE, validity of an RACH occasion;
sending, by the UE, a specific preamble in a target mode;
sending, by the UE, a preamble on a specific RACH occasion resource in the target mode;
updating, by the UE, a mapping relationship between a physical random access channel (PRACH) and a physical uplink shared channel (PUSCH);
determining, by the UE, validity of a PUSCH occasion;
sending, by the UE, a PUSCH of a target random access message at a specific PUSCH occasion in the target mode; or
skipping sending, by the UE, a PUSCH associated with an SSB disabled in a first mode.

11. A synchronization signal block (SSB) indication method, wherein the method comprises:
sending, by a network side device, first indication information to user equipment (UE), wherein the first indication information is used to indicate related information of an SSB of the network side device, wherein
the first indication information is used by the UE to perform a target-related operation, wherein the target-related operation is an operation related to a transmission state of the SSB; and
the related information of the SSB comprises at least one of the following: that the SSB is in a disabled state or an enabled state, a disabled time or an enabled time of the SSB, a disabled pattern or an enabled pattern of the SSB, validity of a random access channel (RACH) occasion corresponding to the SSB, or a state mask of the SSB on the RACH occasion corresponding to the SSB.

12. The method according to claim 11, wherein the sending, by a network side device, first indication information to UE comprises:
sending, by the network side device, the first indication information to the UE in a case that a working mode of the network side device is switched to a target mode, wherein
the first indication information is used to indicate that the transmission state of the SSB is changed; or the first indication information is used to instruct the UE to perform the operation related to the transmission state of the SSB.

13. The method according to claim 11, wherein the sending, by a network side device, first indication information to UE comprises:
sending, by the network side device, the first indication information to the UE by using any one of the following: radio resource control (RRC) signaling, a system information block (SIB), downlink control information (DCI), or a medium access control-control element (MAC CE).

14. The method according to claim 11, wherein the method further comprises:
sending, by the network side device, first configuration information to the UE, wherein the first configuration information is configuration information enabled by the network side device after the network side device enters a target mode, wherein
the first configuration information comprises at least one of the following: a specific RACH configuration in the target mode, indication information that there is a quasi-co-located (QCL) relationship between a disabled SSB and at least one SSB enabled in the target mode, a default reference SSB in the target mode, a specific SSB pattern in the target mode, a configuration of a specific SSB location indication field in the target mode, a specific preamble in the target mode, a physical uplink shared channel (PUSCH) resource of a target random access message in the target mode, a reference signal receiving power (RSRP) threshold in the target mode, or a target mapping relationship; and
the target mapping relationship is a mapping relationship from a combination of RACH occasions to a PUSCH resource unit (PRU) set, or a mapping relationship from a combination of preambles to a PRU set.

15. User equipment (UE), comprising a processor, a memory, and a program or an instruction stored in the memory and executable on the processor, wherein the program or the instruction, when executed by the processor, causes the UE to perform:
receiving first indication information sent by a network side device, wherein the first indication information is used to indicate related information of a synchronization signal block (SSB) of the network side device; and
performing a target-related operation based on the first indication information, wherein the target-related operation is an operation related to a transmission state of the SSB, wherein
the related information of the SSB comprises at least one of the following: that the SSB is in a disabled state or an enabled state, a disabled time or an enabled time of the SSB, a disabled pattern or an enabled pattern of the SSB, validity of a random access channel (RACH) occasion corresponding to the SSB, or a state mask of the SSB on the RACH occasion corresponding to the SSB.

16. The UE according to claim 15, wherein the first indication information is sent in a case that a working mode of the network side device is switched to a target mode; and
the first indication information is used to indicate that the transmission state of the SSB is changed; or
the first indication information is used to instruct the UE to perform operations related to the transmission state of the SSB.

17. The UE according to claim 16, wherein the SSB comprises any one of the following: an SSB actually transmitted by the network side device in the target mode, or all candidate SSBs of the network side device.

18. The UE according to claim 17, wherein in a case that the SSB comprises the SSB actually transmitted by the network side device in the target mode, related information of an SSB before the network side device is switched to the target mode is indicated by the network side device by using an SSB location indication field, and related information of an SSB after the network side device is switched to the target mode is indicated by the network side device by using a target indication field; or
in a case that the SSB comprises all candidate SSBs of the network side device, related information of an SSB before or after the network side device is switched to the target mode is indicated by the network side device by using an SSB location indication field.

19. The UE according to claim 15, wherein the program or the instruction, when executed by the processor, causes the UE to perform:
receiving the first indication information sent by the network side device by using any one of the following: radio resource control (RRC) signaling, a system information block (SIB), downlink control information (DCI), or a medium access control-control element (MAC CE).

20. A network side device, comprising a processor, a memory, and a program or an instruction stored in the memory and executable on the processor, wherein when the program or the instruction is executed by the processor, steps of the synchronization signal block (SSB) indication method according to claim 11 are implemented.
